(19) United States
(12) Patent Application Publication
(10) Pub. No.: US 2008/0280761 A1
(43) Pub. Date: Nov. 13, 2008

(54) Biological Control Of Weeds Using The Metabolites Of Alternaria Alternata

(76) Inventors: Sheng Qiang, Nanjing (CN); Yunfa Dong, Nanjing (CN); Chuanfu An, Nanjing (CN); Bing Zhou, Nanjing (CN); Yunzhi ZHu, Nanjing (CN); Shiguo Chen, Nanjing (CN); Xinbin Dai, Nanjing (CN); Baojiang Dai, Nanjing (CN); Jianguo Cai, Nanjing (CN)

Correspondence Address: MATTHIAS SCHOLL, 14781 MEMORIAL DRIVE, SUITE 1319, HOUSTON, TX, 77079, US

(21) Appl. No.: 11/815,013

(22) PCT Filed: Dec. 29, 2005
(86) PCT No.: PCT/CN2005/002367

§ 371 Date: May 14, 2008

(30) Foreign Application Priority Data
Jan. 28, 2005 (CN) 200510038263.2

(51) Int. Cl. A01N 63/04; A01P 13/00

(52) U.S. Cl. 504/117

(57) ABSTRACT

The present invention is about a method of controlling weeds using the metabolites tenuazonic acid, iso-tenuazonic acid and their salts isolated from the cultures of Alternaria alternata (Fr.) Keissler. The spray of one of these compounds at the rate of 5 to 800 μg/g can cause the main broad leaf, grassy and sedge weeds to hurt, wilt, even dry to death which exhibits herbicidal activity with broad spectrum, quick killing and efficient effect. The addition of adjuvants improves their herbicidal activity.

### FIELD OF THE INVENTION

The present invention relates to the biological control of a wide range of weed species by using metabolites from a strain of the fungus alternaria alternata.

### DESCRIPTION OF THE RELATED ART

With the development of transgenic herbicide-resistant crops, the traditional chemical herbicides with high selectivity, narrow spectrum, and long efficacy will go out gradually. The products with quick activity, broad-spectrum, low toxic, low remnants will be welcome in the herbicide market.

The metabolites of microorganisms or the phytotoxins isolated from microorganisms (focus on the soil actinomycetes and plant pathogenic fungus) are applied to control the weeds as herbicides, which is one hotspot of the study or exploitation of herbicides. Such as bialaphos, herbimycin A, herbicidin and amismycin etc produced by Streptomyces sp., AAL-toxin, tentoxin, alternaric acid and ACRL etc from Alternaria sp., ophiobolins, tryptophol and resorcylides etc coming from Drehslera sp. The broad-spectrum herbicide, glufosinate mimicly synthesized according to the structure of bialaphos has been widely used in the fields of transgenic glufosinate-resistant rape.

Weeding activity of metabolites produced by Alternaria sp. has been documented. Inventors found that crude metabolites of the fungus can be applied to control weeds, and obtained Chinese patent no. ZL00112560.5. The invention illustrate the control of weeds using the pure compounds further purified, isolated, and identified from the crude metabolites. However with respect to applying monomer toxin puried from crude metabolites to control weeds, only the method of controlling weeds of AAL-toxin has been applied for patent. In the patent, the weeding activity of mixture including the toxin is noted, main characteristics comprise that it mostly aims at broad leaf weeds such as nightshade, jimsonweed, redroot pigweed, northern jointvetch, but being almost inefficient to Gramineae weeds; the mixture is the filtrated fluid by filtrating the cultured mediums such as corn powder or rice, effective concentration is beyond 1000 μg/g. Thus its weeding reigon is not so wide as the present invention.

Tenuazonic acid and iso-tenuazonic acid isolated from Alternaria solid and liquid cultured mediums have weeding activity and are isomeric compounds. Physical chemical characteristics of tenuazonic acid, iso-tenuazonic acid: the formula is C10H15NO3, and is a sort of colorless viscous oil; calcium tenuazonate, calcium iso-tenuazonate, magnesium tenuazonate, magnesium iso-tenuazonate, calcium tenuazonate iso-tenuazonate, magnesium tenuazonate iso-tenuazonate, copper tenuazonate iso-tenuazonate etc. are amorphous powder, very soluble in methanol, ethyl acetate, dimethyl sulfoxide etc. organic solvents, slight soluble in chloroform, benzene, glacial acetic acid, acetone etc., bad soluble in low polar solvents such as ligroin etc.

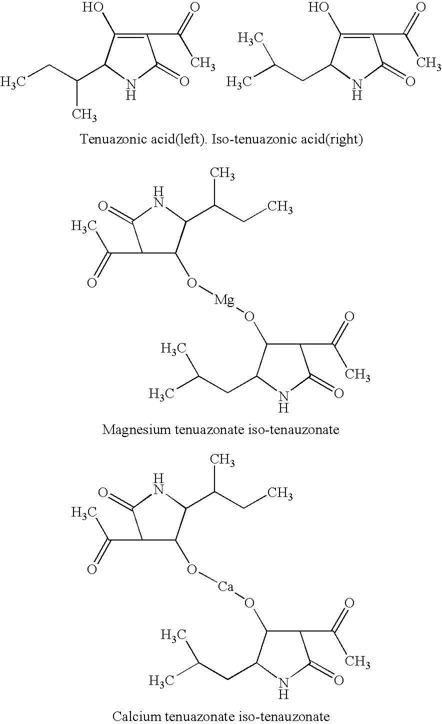

Tenuazonic acid and iso-tenuazonic acid (including their salts) occur not only in Alternaria but also in apple, pepper, tomato, wheat, sorghum, seeds of sunflower, carrot, coleseed, olive, orange, tobacco, rice etc. and rice pathogenic fungus Aspergillus flavus, Pyricularia oryzae, Eleusine coracana Gaertn. etc. microorganisms and the foods such as product of cassava, tomato etc. The activity of tenuazonic acid and iso-tenuazonic acid has been illustrated in some literatures, tenuazonic acid and iso-tenuazonic acid can infect the rice and tobacco plant, and form brown spots, can cause the leaves of tomato chlorophyll loss and necrosis, also can restrain the seedling growth of tomato, rice, wheat, rye, lettuce; tenuazonic acid and iso-tenuazonic acid still can restrain the seminal germination and seedling growth of carrot; have an inhibitory effect of around 50% at 10-4 mol/L on the seed germination of the parasitical weed Striga hermonthica. But with respect to that tenuazonic acid and iso-tenuazonic acid kill directly the growing weeds by stem and leave treatment, not only via inhibiting the seed germination; the species of controlling involves almost all main weeds occurring in cropland, little same as reported parasitical weed Striga hermonthica, the item of controlling follows latter. Particularly calcium tenuazonate iso-tenuazonate, magnesium tenuazonate iso-tenuazonate, copper tenuazonate iso-tenuazonate, iron tenuazonate iso-tenuazonate are new compounds.

The compounds involved in the invention have high activity, still have quite good activity at low concentration as 5 to 70 μg/g, thus they're high efficacious biogenetic chemical herbicides.

The present invention described a method of applying metablic products of Alternaria, tenuazonic acid, iso-tenuazonic acid and their salts, to biocontrol the weeds, its content and embodiments involve the aspects below:

The method of controlling weeds using tenuazonic acid, iso-tenuazonic acid (including their salts): tenuazonic acid, iso-tenuazonic acid (including their salts) were pured from the crude metabolites of solid or fluid cultural Alternaria alternata by column and thin layer chromatograph. Sprayed on the stems and leaves with them from 5 to 800 μg/g, they would make the weeds show the distinct toxic symptom in five days, and then kill the weeds, proper adjuvants will elevate their weedkilling activity.

The method of biocontrol the weeds using tenuazonic acid, iso-tenuazonic acid (including their salts) are calcium tenuazonate, calcium iso-tenuazonate, magnesium tenuazonate, magnesium iso-tenuazonate, copper tenuazonate, copper iso-tenuazonate, iron tenuazonate, iron iso-tenuazonate, sodium tenuazonate, sodium iso-tenuazonate, kalium tenuazonate, kalium iso-tenuazonate and new compounds calcium tenuazonate iso-tenuazonate, magnesium tenuazonate iso-tenuazonate, copper tenuazonate iso-tenuazonate, iron tenuazonate iso-tenuazonate.

The method of biocontrol the weeds using tenuazonic acid, iso-tenuazonic acid (including their salts) are the main gramineous weeds such as common crabgrass, barnyardgrass, goosegrass, green foxtail, equal alopecurus, Japanese alopecurus, Beckmannia syzigachne Fern, wild oat, annual bluegrass, keng stiffgrass, common polypogon, rabbitfoot polypogon, broad leaf weeds such as crofton weed, copperleaf, yerbadetajo, redroot amaranth, tender catchweed bedstraw, narrowleaf vetch, sheathed monochoria, Indian rotala, water ammannia, purslane, flixweed tansymustard, shepherdspurse, common dayflower, wild cress, wormseed mustard, pennsylvania bittercress, geminate speedwell, mouse-ear chickweed and sedges such as needle spikesedge, difformed galingale, rice galingale, dichotomous dimbristylis in the farmland, which shows the broad weeding activity.

The method of biocontrol the weeds using tenuazonic acid, iso-tenuazonic acid (including their salts) is that obvious injuried symptom occurred after 12 hours by stem or leaf treatment, the stems and leaves contacting with the fluid of the compounds chlorosised, whited, wilt, dry rot, even the whole plant died; for the growing plant, they could cause brown spot on the stems or leaves, resulting in rotting to death; the most preferable treatment period for spraying herbicides on the weeds is before the three leaf stage.

The method of biocontrol the weeds using tenuazonic acid, iso-tenuazonic acid (including their salts) is that they are surface active agents, phytogenetic adjuvants, increasing agents and penetrating agents; the main adjuvants are JFC, SDL, tween-80, sodium dodecylsulfonate, NS GL-110, CGN-3, laurocapram, little 4204, SDP.

The method of biocontrol the weeds using tenuazonic acid, iso-tenuazonic acid (including their salts) is that tenuazonic acid, iso-tenuazonic acid (including their salts) obviously reduce the photosynthetic oxygen evolution rate and apparent quanta efficiency. The main action site of the compounds is on thylakoid membrane, which inhibits electron transfer reaction of two photosystems.

During the study of biocontrol of Eupatorium coelestinum L., the inventors found that Eupatorium coelestinum L. naturally come on in the field, so isolated and identified its parasitical epiphytes, and obtained Alternaria alternata (Fr.) Keissler strain no. 501 after studying the respective pathogenicity and toxin-produced characteristic of the strains, and further studied the biological characteristics, methods of culture, technics of vast production, pathogenicity and mechanism, found that its main pathogenitic functionary mechanism is about the production of pathogenitic phytotoxins. The inventors tested the cultured fluid removed the vivid fungus and extracted crude toxin, found that they could cause weeds obvious toxic symptom at the concentration from 1 to 1000 μg/mL in so quickly as 5 hours, and kill entirely the weeds in two days. Tenuazonic acid, iso-tenuazonic acid (including their salts) were obtained by separating via gel colum chromatogram and preparate via thin layer chromatogram the crude metablic products of solid or liquid cultured Alternaria, the activity test showed that the compounds were obvious phytotoxic to the weeds and some crops at 5 to 800 μg/g. The compounds controlled well crofton weed, common crabgrass, beardless barnyardgrass and yerbadetajo (adding a little adjuvant in the treatment of the later weeds) by stem and leaf treatment; the compounds could inhibit efficiently the germination of seed radicles and embryos of the weeds such as common crabgrass, beardless barnyardgrass etc., affect the germinating power; and had some infection on the germination of seed radicles and embryos of some crops such as soybean, rice, wheat and corn etc.

Inoculate the strain cultural blocks cultured in PDA to one kind of followed fluid culture medium.

PSK substrate: filtrate of 200 g potato cooked in water (four layer gauzes), 30 g sucrose, 1 g K2HPO4, water to 1 L.

SCSC substrate: 15 g corn powder, 15 g soybean powder, 30 g sucrose, 3 g CaCO3, water to 1 L.

Or inoculate the strain cultured in the substrates above to the solid substrate RHWH:

RHWH substrate: 50 g rice pollard, 50 g wheat bran, 33.3 mL water.

Liquid culture was to concusively (110 r/m) incubate the inoculated triangle flask for 5 to 8 days at 23° C. to 26° C. in darkness or 12 h/12 h (light/dark), filtrated the culture fluid through filter paper, the filtrate was adsorbed by macropore resin, resolved by ethanol, concentrated at decompression, extracted by ethyl acetate, also concentrated at decompression, and then the crude toxin was obtained. Solid culture was to incubate the inoculated stainless steel basket for 8 to 10 days at 23° C. to 26° C. in darkness or 12 h/12 h (light/dark), and water and ethyl acetate were added to the cultured dry substance dried at 60° C. according to the rate of 2:1:10 for cultured dry substance:water:ethyl acetate (m/v/v, unit: mL or g), and then distilled at decompression to provide the distillate, finally distilled and concentrated at ordinary pressure to provide crude toxin. Above crude toxin was isolated by gel colum chromatogram time after time, puried by TLC times without number, the orange yellow liquid of tenuazonic acid and iso-tenuazonic acid could be get under acid condition, the amorphous powder of the salts of tenuazonic acid and iso-tenuazonic acid, such as calcium tenuazonate, calcium iso-tenuazonate, magnesium tenuazonate, magnesium iso-tenuazonate, sodium tenuazonate, sodium iso-tenuazonate, kalium tenuazonate, kalium iso-tenuazonate and new compounds calcium tenuazonate iso-tenuazonate, magnesium tenuazonate iso-tenuazonate etc., could be obtained under neutral or alkalescent condition. Adding copper acetate and iron acetate to the liquid of tenuazonic acid and iso-tenuazonic acid respectively, copper tenuazonate, copper iso-tenuazonate, copper tenuazonate iso-tenuazonate, iron tenuazonate, iron iso-tenuazonate, iron tenuazonate iso-tenuazonate could be gotten, respectively.

Tenuazonic acid and iso-tenuazonic acid (including their salts) dissolved in little methanol was confected to the liquid at the concentrations of 5 to 40 μg/g with water, the pathogenetic test was conducted by placing the toxic liquid on the slightly wounded leaf of crofton weed with needle. Result shows that the pathogenicity capability to crofton weed of tenuazonic acid and iso-tenuazonic acid increases with the enhance of the concentration, and the spot diameter is 4.9625 mm caused by which on the leaf of crofton weed after 48 hours at 40 μg/g.

The 0.1% adjuvants, such as JFC, SDL, tween-80, sodium dodecylsulfonate, NS GL-110, CGN-3, laurocapram, little 4204, SDP, were added to the 3535 μg/g mixed liquid of tenuazonic acid, iso-tenuazonic acid. The adjuvants were selected according to the action of them to the efficacy display of the compounds by droping the liquid on the isolated leaf segment in plate, the result showed that the eight adjuvants somewhat increased the pathogenic capability of tenuazonic acid, iso-tenuazonic acid to the leaf of common crabgrass, moreover sodium dodecylsulfonate had the best efficiency. The reason is that they could make tenuazonic acid and iso-tenuazonic acid sufficiently spread on the leaf of common crabgrass to enhance the penetrability, promote the transmission of the materials in vivo. Laurocapram and little 4204 also had better efficiency.

Two prescriptions were designed: I. The liquid involving sodium dodecylsulfonate, laurocapram, little 4204 and 35 μg/g tenuazonic acid, iso-tenuazonic acid (salts); II. The liquid involving sodium dodecylsulfonate, laurocapram, JFC and 35 μg/g tenuazonic acid, iso-tenuazonic acid (salts). Two prescriptions were dropped on the ripe leaf of common crabgrass by the method of leaf drop in plate, making for the efficacy improved at about five and six times respectively.

The three-leaf stage weeds in the cropland pot planted in the greenhouse, such as common crabgrass, goosegrass, barnyardgrass, yerbadetajo, copperleaf, small goosefoot, common dayflower, alligator alernanthera, redroot amaranth, prikly sowthistle etc, were stem and leaf treated, and occurring the obvious injury in some weeds in 12 hours after treatment, the leaves of the weeds wilt, chlorosised and whited after two to three days, up to drying rot to death.

The seeds of common crabgrass, beardless barnyardgrass, keng stiffgrass, yerbadetajo, common vetch, wheat, corn, soybean and rice were treated with 5 to 70 μg/g liquids of tenuazonic acid, iso-tenuazonic acid (salts), and the result suggested that the liquids inhibited significantly the elongation of radicles of common crabgrass, beardless barnyardgrass, rice and corn seeds and of embryos of rice and wheat seeds.

It is the effective mechanism of tenuazonic acid, iso-tenuazonic acid (salts) on the weeds that they can affect the plant photosynthesis, obviously reduce the photosynthetic oxygen evolution rate and apparent quanta efficiency. The main action site of the compounds was on thylakoid membrane, inhibiting electron transfer reaction of two photosystems, especially photosystem II, but no effect on the structure and synthesis of membrane protein.

The main advantages and positive effects of the invention involve:
1) The metabolic products of Alternaria were applied to biocontrol the weeds, which have been applied for patent, however, the previous patent didn't involve the structures of particular compounds of the efficient components, which was not good for controlling the content of active components and the quality of products. The present invention is the further study and the progress on the base of the previous patent, the structures of the active compounds were identified after isolation and purification, concentration and purification could improve the efficiency and weeding effect of the product, which prominently decreased the dosage.
2) Because of the simple structures, tenuazonic acid, iso-tenuazonic acid (salts) were easily simulated to artificially synthesize. The invention assured the wide weeding chart of the compounds to the cropland weeds, which can provide template for the chemical synthesized herbicides with analogous structures. Calcium tenuazonate iso-tenuazonate, magnesium tenuazonate iso-tenuazonate, copper tenuazonate iso-tenuazonate, iron tenuazonate iso-tenuazonate were new compounds, their biological activity has positive referent senses to the study on the physiological active mechanism of the compounds, to the chemical synthesis of herbicides.
The structures of Alternaria toxins reported such as tentoxin, alternaric acid and ACRL are complicated, the artificial simulant synthesis of which is relatively difficult, and the cost is very high.
3) It has reported that tenuazonic acid and iso-tenuazonic acid could induce the leaves of some crops brown spots, eg. rice, tomato, wheat, rye, lettuce, tobacco etc., and inhibit the growth of the seedlings, moreover, inhibit the seed germination of the parasitical weed Striga hermonthica, but killing the main weeds in croplands has not been reported. In the invention, tenuazonic acid, iso-tenuazonic acid, their salts in particular can control widely the weeds in fields, causing crofton weed, common crabgrass poisoned symptoms. For the characteristic of acting rapidly, low dosages and little pollution to the environment, they are high efficient biogenic chemical herbicides, which develops the value in use and application prospect of the compounds in biocontrolling weeds. Because of the rapid action of the compounds, they can be used as the substitute products for two destructive herbicides paraquat and glyphosate applied massly. The environmental toxicity of paraquat is higher, and glyphosate acts slowly, kills the weeds beyond at least 10 days.
In present technology, the metabolite of Alternaria, AAL-Toxin is applied to control the weeds, main aims at broad leaf weeds such as nightshade, jimsonweed, redroot pigweed, northern jointvetch, but is almost inefficient to Gramineae weeds; the present invention can be used to control main weeds occurring in the farmland such as Gramineae weeds, eg. common crabgrass, barnyardgrass, goosegrass, green foxtail, equal alopecurus, Japanese alopecurus, Beckmannia syzigachne Fern, wild oat, annual bluegrass, keng stiffgrass, common polypogon, rabbitfoot polypogon; broadleaf weeds, eg. crofton weed, copperleaf, yerbadetajo, redroot amaranth, tender catchweed bedstraw, narrowleaf vetch, sheathed monochoria, Indian rotala, water ammannia, purslane, flixweed tansymustard, shepherdspurse, common dayflower, wild cress, wormseed mustard, pennsylvania bittercress, geminate speedwell, mouse-ear chickweed; sedges, eg. needle spikesedge, difformed galingale, rice galingale, dichotomous dimbristylis.
4) Tenuazonic acid, iso-tenuazonic acid (salts) can control most main weeds in the field by stem or leaf treatment, used conveniently. Furthermore, the compounds are little contaminative and rudimental to the environment due to they have scarcely any activity and be passivated quickly after entering the soil. As a result, the compounds have quite high environmental safety in view of their biogeneration.

### DETAILED DESCRIPTION OF THE INVENTION

### Embodiment 1

21 natural variant strains of Alternaria alternata (Fr.) Keissler, the natural pathogen on Eupatorium adenophorum Spreng., were inoculated on the PDA culture medium, incubated for three days at 25° C. in darkness, and then incubated for seven days at 30 cm under the 15 W ultraviolet lamp, 12 h /12 h (light/dark), and then spore solution was obtained after washing the cultured medium with sterile water. 105 spores were inoculated on 80 mL PSK substrate, and incubated for six days at 25° C. at the rotate speed of 100 rpm. Culture liquid was filtrated through filter paper, and sterilized for 20 minutes at 121° C., provided for germfree filtrate. The third leaf was first cleared with water, and treated for 35 minutes with 0.1% HgCl2, washed three times. The water on the leaf surface was blot up with sterilized filter paper. Needle puncturing at 1 to 2 cm away from the leaf edge resulted in slight wound, and 20 μL germfree filtrate was imbibed to drop on the needle punctured location, at 25±1° C. After 12 hours, the spot diameter was measured under the dissecting microscope, following statistical analysis confirmed the difference of toxin production of the strains. The results were listed in Table 1.

The results in Table 1 suggest that the pathogenicity of four strains, NEW, new 402, new 501, an 501, are obviously higher than that of the other strains, and the pathogenicity of strain NEW is highest. The pathogenic toxin in it should be highest, so it can be incubated for toxin production.

### Embodiment 2

501 strain was inoculated in SCSC liquid substrate, incubated for 5 to 7 days at 25±1° C. in 12 h light/12 h dark at the wave speed of 110 rpm. Culture liquid was filtrated with filter paper, filtrate was centrifuged at high speed, supernatant fluid was filtrated with microaperture membrane for germfree filtrate. Gel column chromatogram of 100 to 200 was discontinuously eluted with different solvent systems according to the polarity from low to high.

The order of elutropic solvent systems added in was petroleum->petroleum:ethyl acetate=5:1->petroleum:ethyl acetate=3:1->petroleum:ethyl acetate=1:1->petroleum:ethyl acetate=1:3->petroleum:ethyl acetate=1:5->ethyl acetate:methanol=5:1->ethyl acetate:methanol=3:1->ethyl acetate:methanol=1:1->ethyl acetate:methanol=1:3->ethyl acetate:methanol=1:5->methanol.

The method of the second gel column chromatogram was the same as the first. The active part eluted by petroleum:ethyl acetate=5:1 and petroleum:ethyl acetate 3:1 from the first gel column chromatogram was further purified on the gel column chromatogram, the order of elutropic solvent systems was petroleum: ethyl acetate=3:1->petroleum:ethyl acetate=2:1->petroleum:ethyl acetate=3:2->petroleum:ethyl acetate=1:1->ethyl acetate->ethanol, the eluted parts were concentrated, and diluted at some times with water for bioactivity test, the active parts were incorporated according to the outspread condition on the gel board for TLC preparation isolation.

The active mixtures from column chromatogram were dissolved in some ethyl acetate, the solution was dropped as strip spot with capillary at the base of TLC preparation board, which was spreaded with outspread solvent and scraped respectively for installing the column. The column was eluted with ethyl acetate or ethanol until there were no compounds outflowing. The conditions of chromatogram were changed to scouted the active compounds, preparated repeatfully, and then an orange brown liquid was obtained after being concentrated in normal pressure at acid condition. Finally, an amorphous orange solid powder was obtained after being concentrated in normal pressure at neutral or alkaline condition.

### Embodiment 3

The mixture of tenuazonic acid and iso-tenuazonic acid was dissolved in little methanol, and was respectively confected to 5 μg/g, 10 μg/g, 15 μg/g, 20 μg/g, 25 μg/g, 30 μg/g, 35 μg/g, 40 μg/g solutions with distilled water, at the same time, methanol control and rinsing control of similar concentration were designed, pathogenicity test was conducted with the method of needle puncture on Eupatorium adenophorum sprengel lamina. Every treatment was repeated six times. The spot diameters were measured with vernier caliper after being wetly incubated for 48 hours at 25° C. in natural light.

The results in Table 2 show that the mixture of tenuazonic acid and iso-tenuazonic acid was high pathogenetic to Eupatorium adenophorum sprengel. The toxicity was already obvious at 5 μg/g, which was close to the toxicity of germfree filtrate, but the difference with control was best apparent (P<0.01).

### Embodiment 4

Magnesium tenuazonate, magnesium iso-tenuazonate and magnesium tenuazonate iso-tenuazonate were dissolved in little methanol, and then was confected to 50 μg/g solutions with distilled water respectively. At the same time, methanol control and rinsing control of similar concentration were designed. The pathogenicity test was conducted with the method of needle puncture on Eupatorium adenophorum spreng lamina. Every treatment was repeated six times. The spot diameters were measured with vernier caliper after being wetly incubated for 48 hours at 25° C. in natural light.

The results in Table 3 show that magnesium tenuazonate, magnesium iso-tenuazonate and magnesium tenuazonate iso-tenuazonate were high pathogenetic to Eupatorium adenophorum spreng, the toxicity was already obvious at 50 μg/g, which was apparently higher than the toxicity of germfree filtrate, the difference was best apparent (P<0.01).

### Embodiment 5

The solution of 35 μg/g tenuazonic acid and iso-tenuazonic acid (salts) was blended respectively with 0.1% JFC, SDL, tween-80, sodium dodecylsulfonate, NS GL-110, CGN-3, laurocapram, little 4204, SDP, the eight adjuvants were selected according to the action of them to the efficacy display of the compounds by droping the liquid on the isolated leaf segment in plate. At the same time, rinsing control CK0, 0.1% adjuvant control CK1, 35 μg/g tenuazonic acid and iso-tenuazonic acid (salts) solution control CK2 were designed, every treatment was repeated six times. The result was analyzed and listed in Table 4, the results showed that the adjuvants increased somewhat the pathogenity of tenuazonic acid, iso-tenuazonic acid (salts) to the leaf of common crabgrass, sodium dodecylsulfonate had the best efficiency, it could make tenuazonic acid and iso-tenuazonic acid sufficiently spread on the leaf of common crabgrass to enhance the penetrability, promote the transmission of the materials in vivo. Laurocapram and little 4204 also had better efficiency.

### Embodiment 6

Two prescriptions were dropped on the ripe leaf of common crabgrass by the method of leaf drop in plate, rinsing control CK0, adjuvant control CK1, 35 μg/g tenuazonic acid and iso-tenuazonic acid (salts) solution control CK2 were designed. Every treatment was repeated six times. The concentrations of adjuvants in the two prescriptions were both 0.1%. The results were listed in Table 5.

Two prescriptions were designed: I. The liquid involving sodium dodecylsulfonate, laurocapram, little 4204 and 35 μg/g tenuazonic acid, iso-tenuazonic acid (salts); II. The liquid involving sodium dodecylsulfonate, laurocapram, JFC and 35 μg/g tenuazonic acid, iso-tenuazonic acid (salts).

The results in Table 5 show that prescription I increased the toxicity of tenuazonic acid, iso-tenuazonic acid (salts) for about 5 times, but was not so good as prescription II. Increase of prescription II on toxicity is much more obvious, over 6 times, and is much higher than prescription I.

### Embodiment 7

The three leaf stage weed seedlings planted in pot in greenhouse were stem or leaf treated with prescription II in example 4. The solution properly wet the surface of weed stem and leaf. Every treatment was repeated three times. At the same time, rinsing control CK1 and adjuvant control CK2 were designed. The state of disease was statisticed after two days. The statistical criterion of disease state was showed in Table 6. Statistical result was listed in Table 7.

The results in Table 7 suggest that prescription II can control the main weeds in the cropland, such as Digitaria sanguinalis, Eleusine indica, Echinochloa crusgalli, Eclipta prostrata, Acalypha australis, Chenopodium serotinum, Commelina communis, Alternanthera philoxeroides, Amaranthus retroflexus, Calystegia hederacea, Sonchus oleraceus etc, the most preferable treatment period for spraying herbicides on the weeds is before the three leaf stage.

### Embodiment 8

Tenuazonates and iso-tenuazonates were dissolved in little methanol, and then were confected to different concentration solutions with distilled water. The solution properly wet the surface of weed stem and leaf. Every treatment was repeated three times. At the same time, rinsing control CK1 and adjuvant control CK2 were designed. The state of disease was statisticed after two days. The statistical criterion of disease state was showed in Table 6. Statistical results were listed in Table 8.

The results in Table 8 suggest that tenuazonates and iso-tenuazonates can control the representative Gramineae weed Digitaria sanguinalis and broad leaf weed Eclipta prostrata in the cropland, and the most preferable treatment period for spraying herbicides on the weeds is before the three leaf stage.

### Embodiment 9

The mixture of tenuazonic acid and iso-tenuazonic acid was dissolved in little methanol, and was respectively confected to 5 μg/g, 8.75 μg/g, 17.5 μg/g, 35 μg/g, 70 μg/g solutions with distilled water, which were used in the experiment of inhibition on seed germination of Digitaria sanguinalis, Echinochloa crusgalli var. praticola, Sclerochloa kengiana, Eclipta prostrata, Vicia sativa, Triticum aestivum, Zea mays, Glycine max, Oryza sativa. The seeds first were cleared with tap water, second treated for three to five minutes with 0.1% HgCl2, the surface wet was blot up with steriled filter paper after being cleared with germfree water. Every treatment was repeated three times, in every repeat, the plant seeds used was 100 grains besides the seeds of wheat, corn, soybean and rice were 30 grains. At the same time, rinsing control CK was designed. The experiment was conducted in dish, the diameter of which was 9 cm, the dosage of the solution or control compounds in every dish was 5 mL, the plants were incubated in illuminating incubator, 12 h light/12 h dark. The germination rate (radicle was as long as seed) was statisticed five days later for wheat, corn, soybean and rice, and ten days later for the other plants, the buds length and roots length were measured, the result was showed in Table 9.

The results in Table 9 suggest that at some concentration, the mixture of tenuazonic acid and iso-tenuazonic acid inhibits the seed germination of the weeds such as Digitaria sanguinalis, Echinochloa crusgalli var. praticola and crops such as rice and wheat, but has little effect on the seed germination of soybean, which can be regard as the base of use range of tenuazonic acid and iso-tenuazonic acid as a bioherbicide.

What is claimed is:

1. The method of biocontrol of weeds using tenuazonic acid, iso-tenuazonic acid and their salts: tenuazonic acid, iso-tenuazonic acid and their salts were purified from the crude metabolites of solid or fluid cultural Alternaria alternata by column and thin layer chromatograph. Sprayed on the stems and leaves from 5 to 800 μg/g, they cause the weeds the obviously diseased symptom, and kill the weeds within five days. The proper adjuvants will improve the weed killing activity.

2. The salts of tenuazonic acid and iso-tenuazonic acid of claim 1 wherein said the method of biocontrol of the weeds using tenuazonic acid, iso-tenuazonic acid and their salts are calcium tenuazonate, calcium iso-tenuazonate, magnesium tenuazonate, magnesium iso-tenuazonate, copper tenuazonate, copper iso-tenuazonate, iron tenuazonate, iron iso-tenuazonate, sodium tenuazonate, sodium iso-tenuazonate, kalium tenuazonate, kalium iso-tenuazonate and new compounds calcium tenuazonate iso-tenuazonate, magnesium tenuazonate iso-tenuazonate, copper tenuazonate iso-tenuazonate, iron tenuazonate iso-tenuazonate.

3. The main weed species of claim 1 wherein said the method of biocontrol of the weeds using tenuazonic acid, iso-tenuazonic acid (including their salts) are the main broad leaf, grassy and sedge weeds, which show the broad-spectrum weed killing activity.

4. The auxiliary agents of claim 1 wherein said the method of biocontrol of the weeds using tenuazonic acid, iso-tenuazonic acid and their salts, proper adjuvants are sodium dodecylsulfonate, NS GL-110, laurocapram, little 4204, which will improve the weed killing activity.
